(19) United States
(12) Patent Application Publication
(10) Pub. No.: US 2008/0201605 A1
(43) Pub. Date: Aug. 21, 2008

(54) Dead man timer detecting method, multiprocessor switching method and processor hot plug support method

(75) Inventors: Qiu-Yue Duan, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/708,492

(22) Filed: Feb. 21, 2007

(51) Int. Cl. G06F 11/16

(52) U.S. Cl. 714/13

(57) ABSTRACT

A Dead man timer detecting method, a multiprocessor switching method, and a processor hot plug support method are provided. A hot spare boot control register communicated with the Dead man timer is used to detect functions of the Dead man timer, such as enabling, timing, disabling, and responding. After an operation system is booted, the Dead man timer is used to achieve automatic switch among multiple processors and the support for the processor hot plug. The method can detect various functions of the Dead man timer, and be switched among multiple processors automatically and periodically, without being limited by the type of operation systems and processors, and realize the support to the processor hot plug, thereby improving the safety for the hot plug operation.

### BACKGROUND OF THE INVENTION

1. Field of Invention

The present invention relates to a computer hardware management method, and more particularly to a timer detecting method, a multiprocessor switching method, and a processor hot plug support method.

2. Related Art

In order to enhance the processing performance of a computer, a conventional solution is installing multiple processors in the same system. The conventional multiprocessor system can be classified into an asymmetrical multiprocessor system and a symmetrical multiprocessor system. In the asymmetrical multiprocessor system, one processor serves as a master processor, and other processors are slave processors of the master processor, which are only used for executing specific functions. In the symmetrical multiprocessor system, tasks are uniformly distributed to each processor, and thus the maximum performance of each processor can be achieved.

In the multiprocessor system, various problems occur, when any processor fails. Currently, a hot spare boot technology has appeared for the multiprocessor system. That is, two processors are installed on the motherboard, and if a first boot processor fails and cannot guide the booting of the system, a second processor can be used for booting the system, which is achieved through a Dead man timer, a hot spare boot control register communicated with the Dead man timer, and other external programmable array logic (PAL) circuits.

Once a multiprocessor system is booted upon being powered on, the motherboard generates a PGOOD signal. A Dead man timer is started according to the PGOOD signal, thereby providing a booting period (2 seconds) for a primary processor. If the primary processor is successfully booted during this booting period, 1 is written into a specific bit STOP_HSB of the hot spare boot control register, and thereby disabling the Dead man timer. If the primary processor fails to be booted normally when the booting period is reached, the motherboard disables the primary processor and boots a second processor. At this time, the Dead man timer is booted once again, thereby providing a booting period (2 seconds) for the second processor. If the second processor is successfully booted during this booting period, 1 is written into the specific bit STOP_HSB of the hot spare boot control register and thereby disabling the Dead man timer. If the second processor fails to be booted normally when the booting period is reached, i.e., 1 is not written into the specific bit STOP_HSB of the hot spare boot control register during the predetermined period of the Dead man timer, it is triggered to change a BOOT_NEXT pin status. The BOOT_NEXT pin drives the Dead man timer to be re-enabled, disables the second processor, and boots the next processor.

Therefore, the conventional art mainly has the following disadvantages.

First, no method for detecting various functions of the Dead man timer is provided in the conventional art, and thus, errors occurred during the operation of the Dead man timer cannot be detected, thereby causing the performance of the multiprocessor system to be degraded.

Second, the processor switching method in the conventional art relies on instructions of the processor itself, which thus is limited by the type of operating systems and processors.

Third, the conventional art is lack of a software support method for processor hot plug.

### SUMMARY OF THE INVENTION

In order to solve the problems and defects in the above conventional art, the present invention is directed to a Dead man timer detecting method, a multiprocessor switching method, and a processor hot plug support method.

A Dead man timer detecting method provided by the present invention is achieved through a hot spare boot control register communicated with the Dead man timer, and the method comprises the following steps:

a) setting a response time and a time slice for the Dead man timer;

b) writing 0 into the 0^{th} bit of the hot spare boot control register, so as to boot the Dead man timer;

c) determining whether or not 0 is written into the 0^{th} bit of the hot spare boot control register successfully, so as to determine whether or not the Dead man timer is booted successfully;

d) if the Dead man timer is successfully enabled, determining a value of the 0^{th} bit of the hot spare boot control register periodically according to the time slice during the response time of the Dead man timer, so as to determine whether or not a timing function of the Dead man timer is normal;

e) writing 1 into the 0^{th} bit of the hot spare boot control register, so as to disable the Dead man timer;

f) determining whether 1 is successfully written into the 0^{th} bit of the hot spare boot control register or not, so as to determine whether or not the Dead man timer is disabled successfully;

g) writing 0 into the 0^{th} bit of the hot spare boot control register, so as to reboot the Dead man timer; and

h) when the response time of the Dead man timer is reached, determining the value of the 0^{th} bit of the hot spare boot control register, so as to determine whether or not the Dead man timer is able to respond normally.

The step d) further comprises: reading the value of the 0^{th} bit of the hot spare boot control register; and determining whether or not the read value of the 0^{th} bit of the hot spare boot control register is equal to 0, and if yes, the timing function of the Dead man timer is normal; if no, the timing function of the Dead man timer is abnormal.

The step h) further comprises: reading the value of the 0^{th} bit of the hot spare boot control register; and determining whether or not the read value of the 0^{th} bit of the hot spare boot control register is equal to 1, and if yes, the Dead man timer is able to respond normally; if no, the Dead man timer cannot respond normally.

A multiprocessor switching method provided by the present invention is used for automatically switching between a first processor and a second processor through a Dead man timer and a hot spare boot control register, which comprises the following steps:

setting a response time for the Dead man timer;

booting the first processor, and writing 0 into the 0^{th} bit of the hot spare boot control register, so as to boot the Dead man timer;

determine whether or not the response time of the Dead man timer is reached, and when the response time of the Dead man timer is reached, the Dead man timer sends a control signal; and

disabling the first processor and booting the second processor according to the control signal.

The control signal is a BOOT_NEXT pin status change signal.

A processor hot plug support method provided by the present invention is used for supporting hot plug of processors through a Dead man timer and a hot spare boot control register, which comprises the following steps:

a1) setting a response time for the Dead man timer;

b1) determining whether or not a plugging processor requiring a hog plug operation is a primary processor operated currently;

c1) if the plugging processor is not the primary processor, disabling the plugging processor, and performing the hog plug operation to the plugging processor;

d1) otherwise, writing 0 into the 0^{th} bit of the hot spare boot control register, so as to boot the Dead man timer; and

e1) when the response time of the Dead man timer is reached, performing processor switching through the Dead man timer, disabling the primary processor, and performing the hog plug operation to the primary processor.

The step b1) further comprises: obtaining a number of the plugging processor requiring the hot plug operation inputted by a user; obtaining a number of the primary processor operated currently; and determining whether or not the number of the plugging processor is the same as the number of the primary processor, so as to determine whether or not the plugging processor is the primary processor.

The step e1) further comprises: when the response time of the Dead man timer is reached, reading a value of the 0^{th} bit of the hot spare boot control register; and when the value of the 0^{th} bit of the hot spare boot control register is 0, performing the step b1).

To sum up, the present invention is able to detect various functions of the Dead man timer, switch among multiple processors automatically and periodically without being limited by the type of the operation systems and the processors, and achieve the software support to the processor hot plug, thereby improving the safety of the hot plug operation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a flow chart of a Dead man timer detecting method according to the present invention;

FIG. 2 is a flow chart of the detecting methods of whether or not the Dead man timer is enabled successfully and whether or not the timing function of the Dead man timer is normal according to the present invention;

FIG. 3 is a flow chart of the detecting method of whether or not the response of the Dead man timer is normal according to the present invention;

FIG. 4 is a flow chart of a multiprocessor switching method according to the present invention after the operation system is booted; and

FIG. 5 is a flow chart of a processor hot plug support method according to the present invention.

### DETAILED DESCRIPTION OF THE INVENTION

Hereinafter, preferred embodiments of the present invention are illustrated in detail with reference to accompanied drawings.

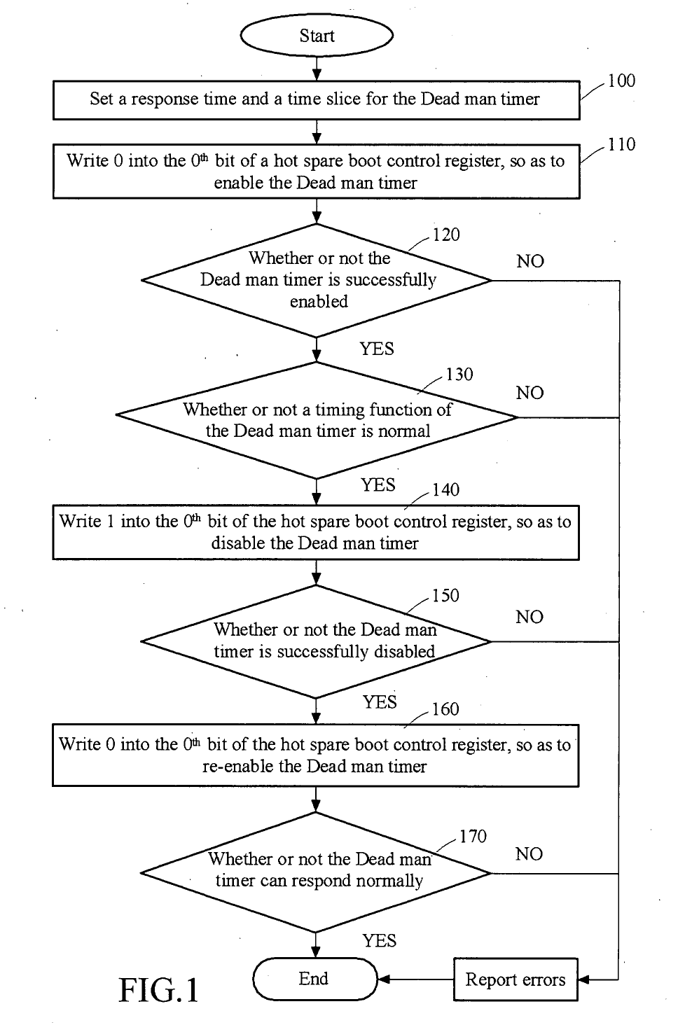

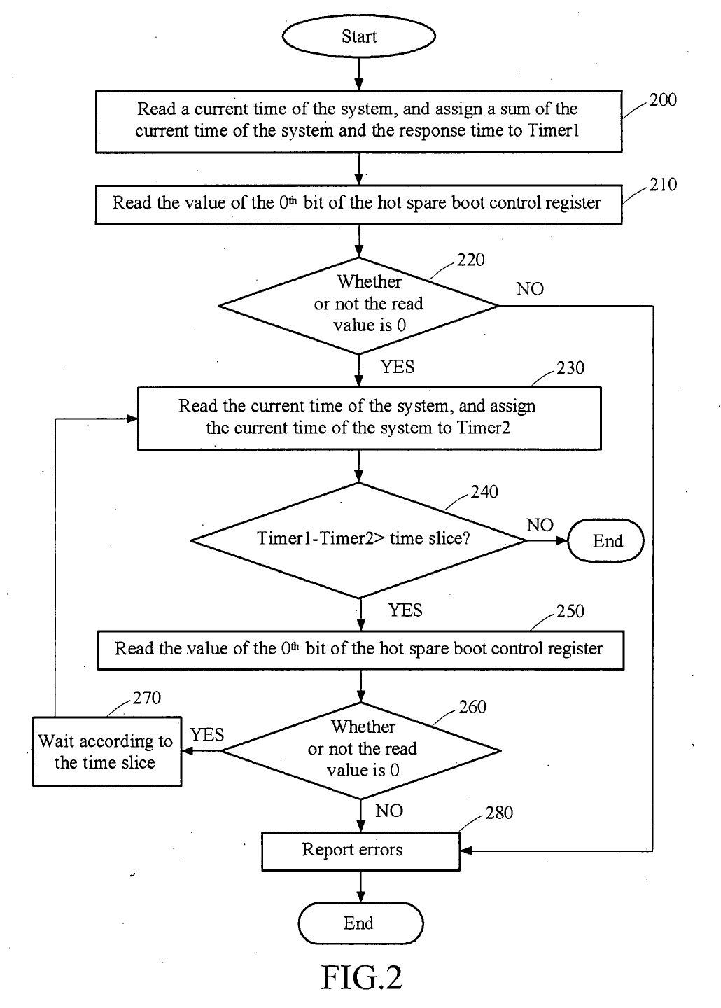

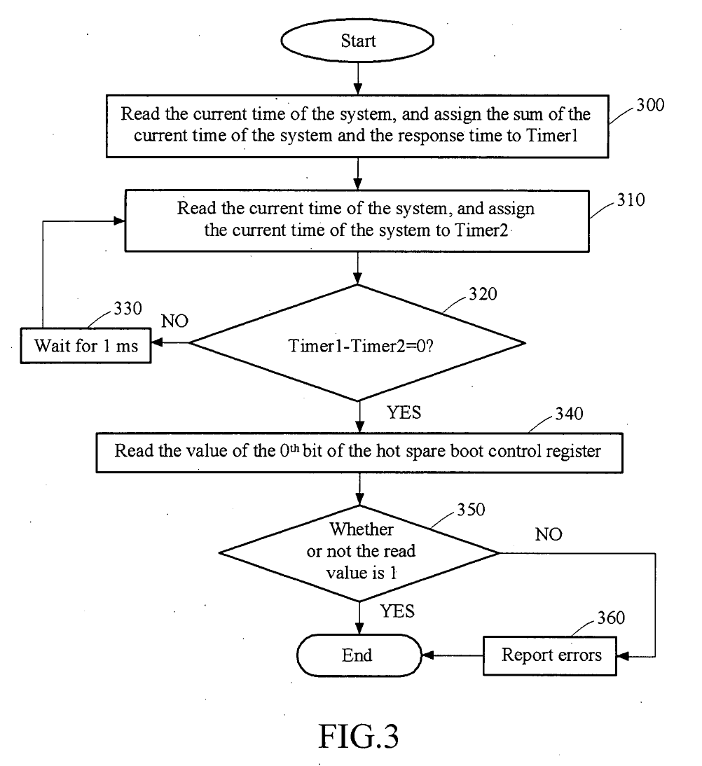

Referring to FIG. 1, it is a flow chart of a Dead man timer detecting method according to the present invention. First, a response time (e.g., 2000 ms) and a time slice (e.g., 10 ms) of the Dead man timer are set (step 100). Next, 0 is written into the 0^{th} bit of a hot spare boot control register communicated with the Dead man timer, so as to enable the Dead man timer (step 110). It is detected whether or not the Dead man timer is successfully enabled (step 120), and the detailed detecting process is described with reference to FIG. 2. When the enabling of the Dead man timer fails, errors are reported to the system by way of sending an interrupt signal (step 180), and finally an alarm is raised to the user, wherein the alarming process can be sending a conventional sound alarm. After the Dead man timer is successfully enabled, it is detected whether or not a timing function of the Dead man timer is normal (step 130), and the detailed detecting process is described with reference to FIG. 2. If the timing function of the Dead man timer is abnormal, errors are reported to the system by way of sending an interrupt signal (step 180), and finally an alarm is raised to the user, wherein the alarming process can be different from the alarming process when the enabling of the Dead man timer fails, so as to be distinguished by the user. If the timing function of the Dead man timer is normal, 1 is written into the 0^{th} bit of the hot spare boot control register, so as to disable the Dead man timer (step 140). It is detected whether or not the Dead man timer is successfully disabled (step 150), and the detecting process is similar to the process for detecting whether or not the Dead man timer is successfully enabled, which can be obtained with reference to the detailed description for the detection of whether or not the Dead man timer is successfully enabled. If the disabling of the Dead man timer fails, errors are reported to the system by way of sending an interrupt signal (step 180), and finally, an alarm is raised to the user. If the Dead man timer is successfully disabled, 0 is written into the hot spare boot control register, so as to re-enable the Dead man timer (step 160). When the response time of the Dead man timer is reached, it is detected whether or not the Dead man timer can respond normally (step 170), and the detailed detecting process is described in detail with reference to FIG. 3. If the Dead man timer cannot respond normally, errors are reported to the system by way of sending an interrupt signal (step 180), and finally, an alarm is raised to the user. If the Dead man timer responds normally, the detection for various functions of the Dead man timer is finished, and no error occurs for the Dead man timer, therefore, the detection process is finished.

Referring to FIG. 2, it is a flow chart of the detecting methods of whether or not the Dead man timer is successfully enabled and whether or not the timing function of the Dead man timer is normal according to the present invention. After the Dead man timer is enabled (step 110), a current time of the system is read, and a sum of the current time of the system and the response time set in the step 100 is assigned to a parameter Timer1 of the Dead man timer (step 200). The value of the 0^{th} bit of the hot spare boot control register is read (step 210), and it is determined whether or not the read value is 0 (step 220). If the read value is not 0, that is, it fails to write 0 into the 0^{th} bit of the hot spare boot control register successfully, the enabling of the Dead man timer fails, errors are reported to the system by way of sending an interrupt signal (step 280), and finally, an alarm is raised to the user. If the read value is 0, the Dead man timer is successfully enabled. Next, the current time of the system is read, and the current time of the system is assigned to a parameter Timer2 of the Dead man timer (step 230). It is determined whether or not the value obtained by subtracting the value of the parameter Timer2 from the value of the parameter Timer1 is larger than the time slice set in the step 100 (step 240). If the value is less than the time slice, the detection process is finished. Otherwise, the value of the 0^{th} bit of the hot spare boot control register is read (step 250), and it is determined whether or not the read value is 0 (step 260). If the read value is 0, it performs waiting according to the time slice (step 270). When the time slice is reached, the step 230 is repeated, so as to detect the timing function of the Dead man timer. If the read value is not 0, the timing function of the Dead man timer is abnormal, and errors are reported to the system by way of sending an interrupt signal (step 280), and finally, an alarm is raised to the user, so as to finish the detection process.

The detection process of whether or not the Dead man timer is successfully disabled (withdrawn) (not shown) is similar to the above detection process of whether the Dead man timer is successfully enabled. That is, the value of the 0^{th} bit of the hot spare boot control register is read, and it is determined whether or not the read value is 1? If the read value is not 1, the disabling of the Dead man timer fails, errors are reported to the system by way of sending an interrupt signal, and finally, an alarm is raised to the user. If the read value is 1, the Dead man timer is successfully disabled.

Referring to FIG. 3, it is a flow chart of the detecting method of whether or not the response of the Dead man timer is normal. As shown in FIG. 1, after the Dead man timer is re-enabled (step 160), the current time of the system is read, and the sum of the current time of the system and the response time set in the step 100 is assigned to a parameter Timer1 of the Dead man timer (step 300). Next, the current time of the system is read, and then assigned to a parameter Timer2 of the Dead man timer (step 310). It is determined whether or not the value obtained by subtracting the value of the parameter Timer2 from the value of the parameter Timer1 is equal to 0 (step 320)? If the value is not equal to 0, i.e., the response time of the Dead man timer has not been reached yet, it waits for 1 ms (step 330), and then the step 310 is repeated. If the value is equal to 0, i.e., the response time of the Dead man timer is reached, the value of the 0^{th} bit of the hot spare boot control register is read (step 340), and it is determined whether or not the read value is 1 (step 350). If the read value is 1, i.e., the response time of the Dead man timer is reached, the value of the 0^{th} bit of the hot spare boot control register is changed from 0 to 1, the Dead man timer responds normally, and the detection process is finished. If the read value is not 1, i.e., the Dead man timer does not respond normally, and errors are reported to the system by way of sending an interrupt signal (step 360), and finally an alarm is raised to the user, so as to finish the detection process.

According to the above description, the present invention can detect various functions of the Dead man timer, such as enabling, timing, disabling (withdrawing), and responding, and inform the user with various alarming manners.

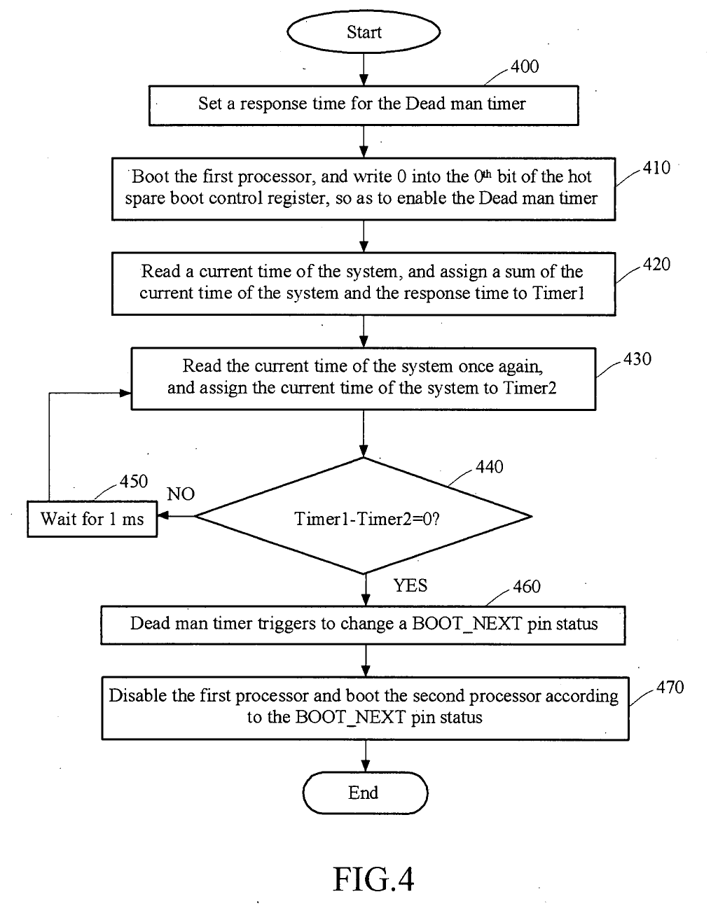

Referring to FIG. 4, it is a flow chart of the multiprocessor switching method according to the present invention after the operation system is booted, which is used for performing automatic switching between a first processor and a second processor through the Dead man timer and the hot spare boot control register. First, a response time of the Dead man timer is set (step 400). Next, the first processor is booted, and 0 is written into the 0^{th} bit of the hot spare boot control register, so as to enable the Dead man timer (step 410). A current time of the system is read, and a sum of the current time of the system and the response time set in the step 400 is assigned to a parameter Timer1 of the Dead man timer (step 420). The current time of the system is read once again, and assigned to a parameter Timer2 of the Dead man timer (step 430). It is determined whether or not the value obtained by subtracting the value of the parameter Timer2 from the value of the parameter Timer1 is equal to 0 (step 440)? If the value is not equal to 0, i.e., the response time of the Dead man timer has not been reached, it waits for 1 ms (step 450), and the step 430 is repeated. If the value is equal to 0, i.e., the response time of the Dead man timer is reached, the Dead man timer sends a control signal, which is used for triggering to change a BOOT_NEXT pin status (step 460). The motherboard of the system disables the first processor and boots the second processor according to the BOOT_NEXT pin status (step 470). During the period for the Dead man timer to wait for the response, the status of the Dead man timer can be monitored through the process of detecting whether or not the response of the Dead man timer is normal, and if it is detected that the response of the Dead man timer is abnormal, the user can be informed to finish this processor-switching process through a sound alarm.

Accordingly, by setting the response time for the Dead man timer, the automatic and periodic switching among multiple-processors can be achieved, without being limited by the type of the operation systems and processors.

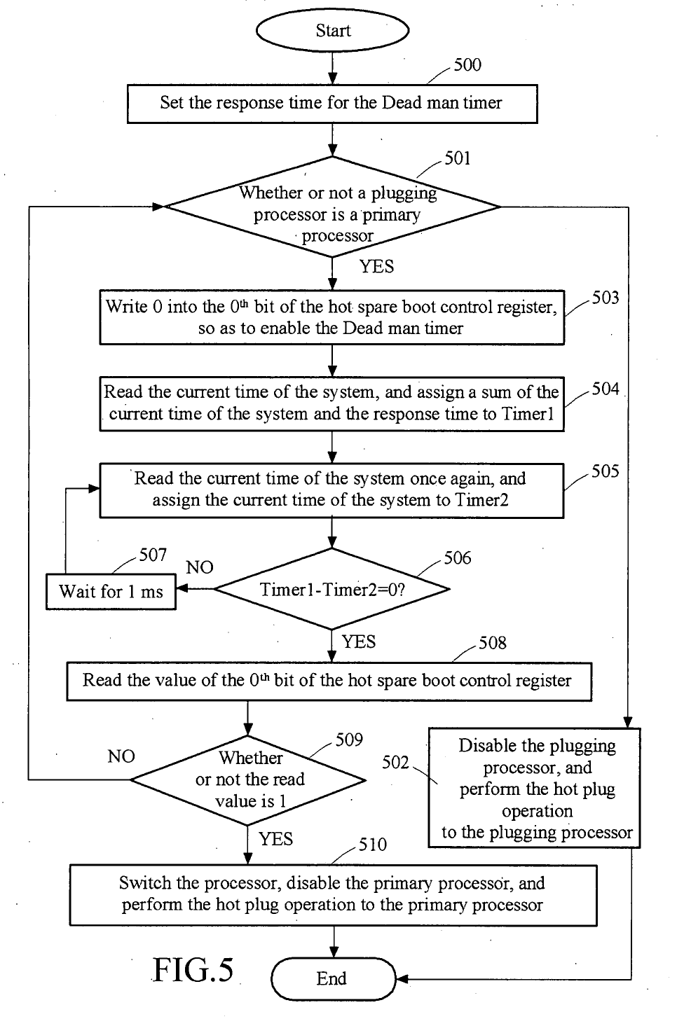

Referring to FIG. 5, it is a flow chart of a processor hot plug support method according to the present invention. First, the response time of the Dead man timer is set (step 500). Next, it is determined whether or not a plugging processor requiring a hot plug operation is a primary processor operated currently (step 501)? The above determining process may include: obtaining a number of the plugging processor requiring the hot plug operation inputted by the user; reading a number of the primary processor of the system operated currently; and determining whether or not the number of the plugging processor is the same as the number of the primary processor, and if the two numbers are the same, the plugging processor requiring the hot plug operation is the primary processor operated currently, otherwise not.

If the plugging processor is not the primary processor operated currently, the system disables the plugging processor, and performs the hot plug operation to the plugging processor (step 502). If the plugging processor is the primary processor operated currently, the processor switching operation is performed. As an improvement, with a dialog box, the user is informed that the hot plug operation cannot be performed to the plugging processor, and the processor switching operation is required. If the user does not select to switch the processor switching, the user is informed once again to finish the process. If the user selects to switch the processor, 0 is written into the 0^{th} bit of the hot spare boot control register, so as to enable the Dead man timer (step 503). Next, the current time of the system is read, and a sum of the current time of the system and the response time set in the step 500 is assigned to a parameter Timer1 of the Dead man timer (step 504). The current time of the system is read once again, and assigned to a parameter Timer2 of the Dead man timer (step 505). It is determined whether or not the value obtained by subtracting the value of the parameter Timer2 from the value of the parameter Timer1 is equal to 0 (step 506)? If the value is not equal to 0, i.e., the response time of the Dead man timer has not been reached, it waits for 1 ms (step 507), and then, the step 505 is repeated. If the value is equal to 0, i.e., the response time of the Dead man timer is reached, and the value of the 0^{th} bit of the hot spare boot control register is read (step 508), and it is determined whether or not the read value is 1 (step 509). If the read value is 1, i.e., the response of the Dead man timer is normal, and the processor switching is performed, the primary processor is disabled, and the hot plug operation is performed to the primary processor (step 510). If the read value is not 1, i.e., the response of the Dead man timer is abnormal, the step 501 is repeated.

In view of the above, the present invention can realize the software support for the processor hot plug, and improve the safety for the hot plug operation through the processor-switching technique.

The invention being thus described, it will be obvious that the same may be varied in many ways. Such variations are not to be-regarded as a departure from the spirit and scope of the invention, and all such modifications as would be obvious to one skilled in the art are intended to be included within the scope of the following claims.

What is claimed is:

1. A Dead man timer detecting method, realized through a hot spare boot control register communicated with a Dead man timer, comprising:
a) setting a response time and a time slice for the Dead man timer;
b) writing 0 into a 0^{th} bit of the hot spare boot control register, so as to enable the Dead man timer;
c) determining whether or not 0 is written into the 0^{th} bit of the hot spare boot control register successfully, so as to determine whether or not the Dead man timer is enabled successfully;
d) if the Dead man timer is successfully enabled, determining a value of the 0^{th} bit of the hot spare boot control register periodically according to the time slice during the response time of the Dead man timer, so as to determine whether or not a timing function of the Dead man timer is normal;
e) writing 1 into the 0^{th} bit of the hot spare boot control register, so as to disable the Dead man timer;
f) determining whether or not 1 is written into the 0^{th} bit of the hot spare boot control register successfully, so as to determine whether or not the Dead man timer is disabled successfully;
g) writing 0 into the 0^{th} bit of the hot spare boot control register, so as to re-enable the Dead man timer; and
h) determining the value of the 0^{th} bit of the hot spare boot control register, so as to determine whether or not the Dead man timer is able to respond normally when the response time of the Dead man timer is reached.

2. The Dead man timer detecting method as claimed in claim 1, wherein the step d) further comprises:
reading the value of the 0^{th} bit of the hot spare boot control register; and
determining whether or not the read value of the 0^{th} bit of the hot spare boot control register is equal to 0, wherein if yes, the timing function of the Dead man timer is normal; if no, the timing function of the Dead man timer is abnormal.

3. The Dead man timer detecting method as claimed in claim 1, wherein the step h) further comprises:
reading the value of the 0^{th} bit of the hot spare boot control register; and
determining whether or not the read value of the 0^{th} bit of the hot spare boot control register is equal to 1, wherein if yes, the Dead man timer is able to respond normally; if no, the Dead man timer cannot respond normally.

4. A multiprocessor switching method, for automatically switching between a first processor and a second processor through a Dead man timer and a hot spare boot control register, comprising:
setting a response time for the Dead man timer;
booting the first processor, and writing 0 into a 0^{th} bit of the hot spare boot control register, so as to enable the Dead man timer;
determining whether or not the response time of the Dead man timer is reached, wherein when the response time of the Dead man timer is reached, the Dead man timer sends a control signal; and
disabling the first processor and booting the second processor, according to the control signal.

5. The multiprocessor switching method as claimed in claim 4, wherein the control signal is a BOOT_NEXT pin status change signal.

6. A processor hot plug support method, for supporting a hot plug of processors through a Dead man timer and a hot spare boot control register, comprising:
a1) setting a response time for the Dead man timer;
b1) determining whether or not a plugging processor requiring a hog plug operation is a primary processor operated currently;
c1) if the plugging processor is not the primary processor, disabling the plugging processor, and performing the hog plug operation to the plugging processor;
d1) otherwise, writing 0 into a 0^{th} bit of the hot spare boot control register, so as to enable the Dead man timer; and
e1) switching among processors through the Dead man timer, disabling the primary processor, and performing the hog plug operation to the primary processor when the response time of the Dead man timer is reached.

7. The processor hot plug support method as claimed in claim 6, wherein the step b1) further comprises:
obtaining a number of the plugging processor requiring the hot plug operation inputted by a user;
obtaining a number of the primary processor operated currently; and
determining whether or not the number of the plugging processor is same as the number of the primary processor, so as to determine whether or not the plugging processor is the primary processor.

8. The processor hot plug support method as claimed in claim 6, wherein the step e1) further comprises:
reading a value of the 0^{th} bit of the hot spare boot control register when the response time of the Dead man timer is reached; and
performing the step b1) when the value of the 0^{th} bit of the hot spare boot control register is 0.
